(19) United States
(12) Patent Application Publication
(10) Pub. No.: US 2003/0228451 A1
(43) Pub. Date: Dec. 11, 2003

(54) Transfer material, image forming method and image forming apparatus

(75) Inventor: Motohiro Ogura, Kashiwa-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/414,213

(22) Filed: Apr. 16, 2003

(30) Foreign Application Priority Data
Apr. 16, 2002 (JP) 112901/2002 (PAT)
Mar. 10, 2003 (JP) 063387/2003 (PAT)

(51) Int. Cl. B32B 3/00

(52) U.S. Cl. 428/195.1

(57) ABSTRACT

An image transfer material on which an image is printed with ink and then onto which a toner image is transferred by an image forming apparatus, wherein a toner image is transferred onto the transfer material which is fed in a machine direction of a base paper thereof; wherein a water elongation MD of the base paper in the machine direction and a water elongation CD thereof in a direction perpendicular to the machine direction satisfy:

CD/MD≧10.

### FIELD OF THE INVENTION AND RELATED ART

The present invention relates to a transfer material usable with an electrophotographic apparatus, an electrostatic recording apparatus or the like in which a toner image is formed, the transfer material having been subjected to printing with ink before it is fed into the apparatus. The present invention also relates to an image forming method or an image forming apparatus using such a transfer material.

In the field of color recording device using an electrophotographic type, digital system has been widely used. With the digitalization, the requirements on the transfer material is increased to such an extent that the material conventionally used normal printing is to be usable with the electrophotographic image forming apparatus or the like. Particularly, there is a demand for forming toner image through an electrophotographic type on usual high-quality paper which has been printed by a printing machine. By doing so, a certain image area is mass-printed, and then modifications are imparted through the electrophotographic system, by which printing costs are reduced.

Japanese Laid-open Patent Application Hei. 9-15893 discloses image formation on an ink-preprinted sheet or paper. Japanese Laid-open Patent Application 2002-29149 deals with paper of ink Jet printing.

However, since the pre-printed paper has received printing ink prior to image formation through the electrophotographic process, the paper contains a larger amount of water the normal paper for electrophotographic process, and therefore, the sheet is easily curled. This may result in the paper wraps around the photosensitive drum, the transfer drum or the intermediary transfer drum which is used in the electrophotographic copying machine, printer or the like.

To avoid this, the sheet of paper is fed in such an orientation that curling does not easily occur (MD direction). However, it has been found that curling occurs unless the directionality of the fibers of the paper is very uniform. Here, “MD” means “paper machine direction”, in which direction the fibers of paper tended to be aligned. The above-mentioned Japanese Laid-open Patent Application Hei 9-15893 mentions to pre-printed paper, but it does not recognize the problem of curling of paper or the solation to the problem. The above-mentioned Japanese Laid-open Patent Application 2002-29149 is related to recording paper for ink jet printing and discloses a selection of cutting direction in relation with the paper machining direction of the paper so as to avoid the problem of contamination of the paper with ink which might result from waved paper is unintentionally contacted to the printing head. However, this publication does not recognize the problem of the feeding due to the curling or the solation to the problem.

### SUMMARY OF THE INVENTION

Accordingly, it is a principal object of the present invention to provide a transfer material, an image forming method using the transfer material and an image forming apparatus using the transfer material, with which when a toner image is transfer vide onto a transfer material which is a preprinted (ink) paper, the curl production is suppressed so that stabilized sheet feeding is carried out.

According to an aspect of the present invention, there is provided an image transfer material on which an image is printed with ink and then onto which a toner image is transferred by an image forming apparatus, wherein a toner image is transferred onto the transfer material which is fed in a machine direction of a base paper thereof; wherein a water elongation MD of the base paper in the machine direction and a water elongation CD thereof in a direction perpendicular to the machine direction satisfy:

CD/MD≧10.

According to a further aspect of the present invention, there is provided an image forming method comprising a step of printing an image on a transfer material with ink; a step of transferring a toner image onto said transfer material after said printing step; wherein a toner image is transferred onto the transfer material which is fed in a machine direction of a base paper thereof; wherein a water elongation MD of the base paper in the machine direction and a water elongation CD thereof in a direction perpendicular to the machine direction satisfy: CD/MD≧10.

According to a further aspect of the present invention, there is provided an image forming apparatus comprising image forming means for forming a toner image onf an image bearing member: transferring means for transferring a toner image from said image bearing member onto a transfer material while the transfer is being fed in a direction which is the same as a machine direction of a base paper of the transfer material, the transfer material having been subjected printing with ink; wherein a water elongation MD of the base paper in the machine direction and a water elongation CD thereof in a direction perpendicular to the machine direction satisfy:

CD/MD≧10.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a sectional view of a transfer material (a) according to the embodiment of the present invention, and is a schematic view (b) illustrating a transfer sheet feeding direction, a MD direction, and a CD direction.

FIG. 2 illustrates a structure of an image forming apparatus according to the embodiment of the present invention.

### DESCRIPTION OF THE PREFERRED EMBODIMENTS

Referring to the accompaniment drawings, the preferred embodiments of the present invention will be described.

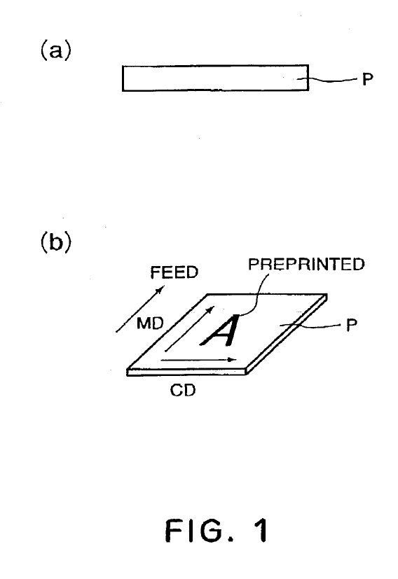

FIG. 1 shows a sectional view (a) of a transfer material P according to an embodiment of the present invention. The base paper may be normal paper such as acidic or neutral quality paper, acid-free paper, woody paper, recycled paper or the like. However, it is desirable that (water elongation in the CD direction)/(water elongation in MD direction) is not less than 10, where the water elongation is determined by by J.TAPPI paper pulp test method No.27. Here, the CD means “Cross Direction” which is a direction perpendicular to the machine direction. A large water elongation means that fibers of the paper are easily separable from each other, that is, the directions of the fibers are riot aligned. In the direction in whihc the water elongation is large, the paper easily shrinks and easily curls. If the (water elongation in the CD direction)/(water elongation in the MD) is smaller than 10, the water elongation in the MD direction is relatively large, so that shrinkage of the paper is relatively large.

Therefore, the curling may occur in the MD direction. Therefore, with such paper, even when the paper is fed in the MD direction in t image formation, the paper may wrap around the image bearing member, so that it is not properly fed.

In order to prevent the shrinkage in the MD direction, the directions of the fibers of the paper are aligned. For example, when limitation is to be imparted in the base paper, the vibration on wire in the paper machine is strengthened, or pulp having relatively longer fibers are used to raise a paper machining speed. As another method, the elongation in the MD direction is prevented during the pre-printing operation. This is accomplished by increasing, in the printing operation, tension imparted to the paper is increased in the MD MD direction by which the fibers are aligned in the MD direction. By properly adjusting these methods, (water elongation in CD direction)/(water elongation in MD direction) can be made not less than 10.

As a method of printing on the base paper, there are offset printing, gravure printing, silk-screen printing, relief printing or another conventional printing method with the use of conventional bubble generation ink, printing ink, resin material, paste or the like. Through the methods, pre-prints are produced.

It is desirable that smoothness of the preprinted paper determined by JIS P-8119 is not less than 30 sec. If it is lower than 30 sec, the surface is too rough to provide a satisfactory print quality. Such a surface property may be given by the nature of the base paper. As an alternative, the base paper may be coated with a coating layer. The coated layer may be an ordinary pigment. For example, it may be mineral pigment such as ground calcium carbonate, precipitated calcium carbonate light, titanium dioxide, aluminum hydroxide, satin white, talc, calcium sulfate, barium sulfate, zinc oxide, magnesium oxide, magnesium carbonate, amorphous silica, colloidal silica, white carbon, kaoline, baked kaoline, delaminated kaoline, aluminosilicate, sericite, bentonite or the like: polystyrene resin material fine particle: urea-formaldehyde, fine hollow particles; organic pigment, which may be used alone or in combination.

An adhesive material for the coating layer may he an ordinary one, that is, water-soluble adhesive material, emulsion, latex or the like which exhibits a strong bonding strength with the base material and the additive such as pigment or the like. Examples include water-soluble resin material such as polyvinyl alccohol, modified polyvinyl alcohol, starch, gelatine, casein, methyl cellulose, hydroxyethyl cellulose, amide acrylate acrylate ester copolymer resin material, amide acrylate acrylin resin material, methacrylic acid ternary copolymer resin material, styrene acrylic resin material, isobutylene maleic anhydride resin material, carboxymethyl cellulose, or the like: acrylic emulsion. Polyvinyl acctate emulsion, vinylidene chloride emulsion, polyester emulsion, vinylidene chloride emulsion, polyester emulsion, styrene-butadiene latex, acrylonitrile-butadiene latex, acrylic nytril-butadiene latex or the like.

As regards the coating method, it may be carried out by a gate roll coating using an on-machine coater, and size press is carried out, and then calendering process is carried out to provide a smooth surface property.

Alternatively, off-machine coater which carries out blade coating, air knife coating, roll coating, curtain coating, or the like, is usable. Furthermore, a silk-screen method may carried out.

The surface resistivity of the pre-printed paper is preferably within a predetermined range. More particularly, it is 5×10¹⁰ Ω/□−5×10¹³ Ω/□ under 23° C./50% RH ambience. If it is smaller than 5×10¹⁰ Ω/□, so-call transferring current release may occur, or electrostatic attraction onto the conveyer belt is difficult. If it is larger than 5×10¹³ Ω/□, electrostatic attraction force is too strong, with the result that sheet is not easily peeled off a transfer belt.

The surface resistance can be adjusted by an electroconductive material such as sodium chloride, potassium chloride, sodium sulfate, potassium sulfate, styrene=maleate copolymer, quarternary ammonium salt; cation resistance reducing material; anion resistance reducing material.

The water content of the base paper before pre-printing is preferably 6-10% which is higher than normal water content of paper for electrophotography. If it is lower than 6%, waving is too significant when the pre-printing is carried out. If it is higher than 10%, an adjustment for providing the appropriate water content suitable to t electrophotography is difficult. These limitations do not apply to the water content of the preprint paper supplied to the electrophotographic apparatus.

As regards the base paper on which the pre-printing is effected, the basis weight is preferably not less than 60 g/m² and not more than 130 g/m². If the basis weight is less than 60 g/m², the rigidity of the paper is to small with the result of worsened curling to such an extent that it is not usable despite any adjustment of the water elongation CD/MD. If the opposite exceeds 130 g/m², the rigidity is large so that curling does not occur any way, and therefore, change in the water elongation CD/MD is not influential to the amount of t curling.

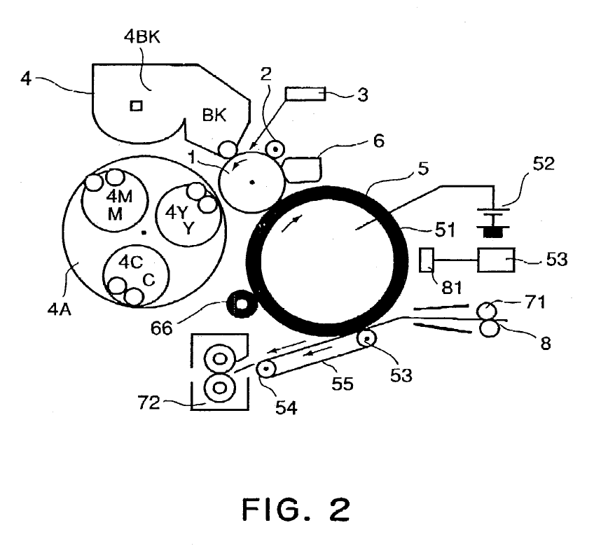

FIG. 2 shows an example of an electrophotographic apparatus with which a pre-printed transfer sheet according to the present invention is usable.

The electrophotographic apparatus comprises, as shown in FIG. 2, a rotatable photosensitive drum 1 (image bearing member), developing means 4, exposure means 3 for forming an electrostatic latent image in accordance with the image information on an outer surface of the photosensitive drum 1 thra exposure process step, rotatable transferring means 5 in the form of a roller for transferring the toner image from said photosensitive drum, and fixing means 72 for fixing the transferred image on the transfer material S by heat and pressure.

The photosensitive drum 1 includes a drum base member of metal and a photosensitive layer of OPC (organic photo-semiconductor) or the like on the outer surface, and is rotated in the direction indicated by an arrow by driving means (unshown). Around the photosensitive drum 1, the charging means 2, the exposure means 3, the developing means 4, the transferring means 5 and cleaning means 6 and the like are disposed in this order in the rotational direction thereof.

The charging means 2 includes a charging roller (charging member) 21 disposed contacted to the surface of the photosensitive drum 1, a charging bias voltage source (unshown) for applying a charging bias to the charging roller 21. It functions to uniformly charges the surface of the photosensitive drum 1 to a predetermined potential of a predetermined polarity.

The exposure means 3 comprises a laser oscillator and a polygonal mirror (not shown) and the like, it exposes the surface of the photosensitive drum 1 to image light on the basis of image information to forma an electrostatic latent image on the surface of the photosensitive drum 1.

The developing device 4 has a stationary black developing device 4BK: and it has three developing devices which is movable carried on the rotary 4A, that is, yellow (Y), magenta (M), cyan (C) developing devices 4Y, 4M, 4C.

The three movable developing device 4Y, 4M, s 4C, are selectively brounght to be opposed to the photosensitive drum 1, corresponding to the electrostatic latent images on the photosensitive drum 1. By the developing devices 4Y, 4M, 4C, toner particles are deposited to form toner iamges of respective colors.

The transferring means 5 is provided with an intermediary transfer drum 51 (cylindrical image bearing member).

The intermediary transfer drum 51 is rotated, whiled being supplied with a primary transfer bias from a primary transfer bias voltage source 52, so that toner image is transferred from the photosensitive drum 1 onto the intermediary transfer drum 51 (primary transfer).

The cleaning means 6 includes a cleaning blade (unshown) contacted to the surface of the photosensitive drum 1, and removes untransferred toner from the photosensitive drum 1.

Below t intermediary transfer drum 51, there is provided a secondary transfer belt 55 extended around a secondary transfer roller 53 and a driving roller 54.

The secondary transfer roller 53 is supplied with a secondary transfer bias from t secondary transfer bias voltage source (unshown), so that four color toner images are transferred all together from t intermediary transfer drum 51 onto the transfer material S such as paper fed by the registration roller 71 (secondary transfer).

The transfer material S after the toner image is transferred (secondary transfer) is fed to the fixing device 72 where it is heated and pressed so that toner image is fixed on the transfer material S. If the water elongation of the transfer material S described above is not more than 10 (CD/MD), the transfer material S may wrap around the transfer drum 51 due to curling, with the result that transfer material S is not fed to the fixing device 72 but is jammed.

(Embodiment 1)

A pulp suspension is prepared by mixing 3.2 weight % water-soluble binder, 1.5% NaCl, using 6 weight % of oxide titanium, 6 weight % of kaoline, 0.5 weight % of aluminum sulfate, 0.3% rosin sizing agent (dry base weight percentages). Using the pulp suspension. L. B. K. P (pulp from broad leaf tree) is processed by a Fourdrinier paper machine and dryed into 5% of water content, and then, calendering process is carried out to provide 50 sec of smoothness, thus providing a base paper having a basis weight of 81.4 g/m². At this time, the vibration amount of the wire part is set 3 times the normal amount (the amplitude is 8 mm, and 1200 ppm). The quality paper thus produced is fed into a gravure printing machine and is coated at both sides with gravure ink, by which the basis weight becomes 82.2 g/m². The water elongation of the paper is measured in each of MD direction and CD direction. It was 0.1% in the MD direction, and 2.6% in the CD direction so that (water elongation in CD direction)/(water elongation in MD direction) was 26.

The surface resistivity was 1×10¹¹ Ω/□. It was fed into a full-color copying machine P680 available from Canon Kabushiki Kaisha. Japan. The feeding direction is the same as the MD direction of the paper. The wrapping around the intermediary transfer drum is checked. The results are shown in Table 1. It has been confirmed that pre-printed paper wraps around theby generation with respect to the sheet feeding direction.

(Embodiment 2)

Base paper having a basis weight of 104.7 g/m² was produced through the method which was the same as with Embodiment 1 except that pulp was a mixture of acicular tree pulp and broad leaf tree pulp of 50: 50, and the vibration amount of the wire part is 2 times the normal amount. The pre-printing is carried out in the same manner as with Embodiment 1. The water elongations were 0.05% in the MD direction, and 2.8% in the CD direction so that (water elongation in CD direction)/(water elongation in MD direction) was 56.

The smoothness of the paper was 48 sec, and t surface resistivity was 3×10¹¹ Ω/□. The paper was fed into the machine P680 similarly to Embodiment 1. The direction of sheet feeding is the same as the MD direction of the paper. The winding or wrapping aroud the intermediary transfer drum was checked. The results are also shown in Table 1.

The result was that paper did not wrap around t transfer drum in the sheet feeding direction, so that pre-printed paper was stably fed.

(Embodiment 3)

In modified Embodiment 1, the vibration amount of the wire was normal. In the gravure printing, the paper was fed in the MD direction of the paper, and the feeding speed was 2 times the conventional feeding speed (200 m/min). The conditions were the same as with Embodiment 1 in the other respects. According to this modified embodiment, the stretching force applied to the paper in the MD direction during the pre-printing is strong, by which the directions of the fibers are aligned better in the MD direction. The water elongations were 0.05% in the MD direction, and was 2.4% in the CD direction, so that (water elongation in the MD direction)/(water elongation in the CD direction) was 48.

The smoothness of the paper was 46 sec, and the surface resistivity was 2×10¹¹ Ω/□. The paper was fed into the machine P680 similarly to Embodiment 1. The direction of sheet feeding is the same as the MD direction of the paper. The winding or wrapping around the intermediary transfer drum was checked. The results are also shown in Table 1.

The result was that paper did not wrap around t transfer drum in the sheet feeding direction, so that pre-printed paper was stably fed.

### COMPARISON EXAMPLE 1

As a comparison example, Embodiment 1 is modified such that amount of the wire part of the paper machine is normal. The water elongation was 0.5% in the MD direction and 2% in CD direction, so that (water elongation in CD direction)/(water elongation in /MD direction) was 4. The wrapping around the intermediary transfer drum was checked. The results are also shown in Table 1.

The result was that degree of curling of the paper in the sheet feeding direction was so large that paper wrapped around the intermediary transfer drum with the result of improper feeding, and no image was formed in the electrophotographic type printing.

### COMPARISON EXAMPLE 2

Embodiment 1 was modified such that water content of the base paper was 4%, and was the same as with Embodiment 1 in the other respects. The water content of the base paper was so small that paper was waved. In the gravure printing, and the gravure printing operation was not carried out satisfactorily.

### COMPARISON EXAMPLE 3

This example was similar to Embodiment 1, but the calendering process for the base paper was not effected so that smoothness was normal, that is, 13 sec. The pre-printed paper was produced through the gravure printing similarly to Embodiment 1. The gravure printing suitable property was not satisfactory with the result of non-uniformity defect because of the poor smoothness.

### COMPARISON EXAMPLE 4

This example is similar to Embodiment 1, but the amount of NaCl was 3 times, and the surface resistance was 8×10⁸ Ω/□. The conditions were the same as Embodiment 1 in the other respects.

The water elongation was 0.1% in the MD direction and 2.6% in the CD direction. The wrapping around the intermediary transfer drum was checked. The results are also shown in Table 1.

The result was that paper did not wrap around the intermediary transfer drum in the sheet feeding direction, but an image defect appeared in the electrophotographic due to the too low resistance.

TABLE 1

| | Emb1 | Emb2 | Emb3 | Comp. 1 | Comp. 2 | Comp. 3 | Comp. 4 |
|---|---|---|---|---|---|---|---|
| Pulp | LBKP100 | 50:50 | LBPK100 | LPK100 | LBPK100 | LBPK100 | LBPK100 |
| Vibrat'n | 3 times | 2 times | nrml | nrml | 3 times | 3 times | 3 times |
| Wtr cntnt | 7% | 7% | 9% | 7% | 4% | 7% | 7% |
| Printing | grvr | grvr | grvr | grvr | grvr | grvr | grvr |
| spd | nrml | nrml | 2 times | nrml | nrml | nrml | nrml |
| MD % | 0.10 | 0.05 | 0.05 | 0.5 | 0.1 | 0.1 | 0.1 |
| CD % | 2.60 | 2.8 | 2.4 | 2 | 2.6 | 2.6 | 2.6 |
| CD/MD | 26 | 56 | 48 | 4 | 26 | 26 | 26 |
| Sur | 1.00E+11 | 3.00E+11 | 2.00E+11 | 1.00E+11 | 1.00E+11 | 1.00E+11 | 8.00E+08 |
| Reg | | | | | | | |
| Smth | 50 | 48 | 46 | 50 | 50 | 13 | 50% |
| Wrapping | No | No | No | Yes | No | No | No |
| Print | Good | Good | Good | Good | NG | NG | Good |
| property | | | | | | | |
| image | Good | Good | Good | Not | Good | Good | NG |
| | | | | Possible | | | |

While the invention has been described with reference to the structures disclosed herein, it is not confined to the details set forth and this application is intended to cover such modifications or changes as may come within the purpose of the improvements or the scope of the following claims.

What is claimed is:

1. An image transfer material on which an image is printed with ink and then onto which a toner image is transferred by an image forming apparatus,
wherein a toner image is transferred onto the transfer material which is fed in a machine direction of a base paper thereof;
wherein a water elongation MD of the base paper in the machine direction and a water elongation CD thereof in a direction perpendicular to the machine direction satisfy:
CD/MD≧10.

2. A transfer material according to claim 1, wherein a water content of the base paper is not less than 6% and not more than 10%.

3. A transfer material according to claim 1, wherein a basis weight of the base paper is not less than 6 g/m² and not more than 130 g/m².

4. A transfer material according to claim 1, wherein the smoothness of the surface of the transfer material after the printing with ink is not less than 30 sec.

5. A transfer material according to claim 1, wherein a surface resistivity of said transfer material after the printing with the ink is not less than 5×10¹⁰ Ω/□ and not more than 5×10¹³ Ω/□ under 23° C. and 50% RH.

6. A transfer material according to claim 1, wherein the image forming apparatus includes an image bearing member for carrying a toner image, and a toner image is transferred onto the transfer material from said image bearing member.

7. A transfer material according to claim 1, wherein a coating layer is provided on a surface of said base paper.

8. An image forming method comprising:
a step of printing an image on a transfer material with ink;
a step of transferring a toner image onto said transfer material after said printing step;
wherein a toner image is transferred onto the transfer material which is fed in a machine direction of a base paper thereof;
wherein a water elongation MD of the base paper in the machine direction and a water elongation CD thereof in a direction perpendicular to the machine direction satisfy: CD/MD≧10.

9. A method according to claim 8, wherein a water content of the base paper is not less than 6% and not more than 10%.

10. A method according to claim 8, wherein a basis weight of the base paper is not less than 60 g/m² and not more than 130 g/m².

11. A method according to claim 8, wherein the smoothness of the surface of the transfer material after the printing with ink is not less than 30 sec.

12. A method according to claim 8, wherein a surface resistivity of said transfer material after the printing with the ink is not less than 5×10¹⁰ Ω/□ and not more than 5×10¹³ Ω/□ under 23° C. and 50% RH.

13. A method according to claim 8, wherein the image forming apparatus includes an image bearing member for carrying a toner image, and a toner image is transferred onto the transfer material from said image bearing member.

14. A method according to claim 8, wherein a coating layer is provided on a surface of said base paper.

15. An image forming apparatus comprising:
image forming means for forming a toner image onf an image bearing member;
transferring means for transferring a toner image from said image bearing member onto a transfer material while the transfer is being fed in a direction which is the same as a machine direction of a base paper of the transfer material, the transfer material having been subjected printing with ink;
wherein a water elongation MD of the base paper in the machine direction and a water elongation CD thereof in a direction perpendicular to the machine direction satisfy:
CD/MD≧10.

16. An apparatus according to claim 15, wherein a water content of the base paper is not less than 6% and not more than 10%.

17. An apparatus according to claim 15, wherein a basis weight of the base paper is not less than 60 g/m² and not more than 130 g/m^{2.}

18. An apparatus according to claim 15, wherein the smoothness of the surface of the transfer material after the printing with ink is not less than 30 sec.

19. An apparatus according to claim 15, wherein a surface resistivity of said transfer material after the printing with the ink is not less than 5×10¹⁰ Ω/□ and not more than 5×10¹³ Ω/□ under 23° C. and 50% RH.

20. An apparatus according to claim 15, wherein the image forming apparatus includes an image bearing member for carrying a toner image, and a toner image is transferred onto the transfer material from said image bearing member.

21. An apparatus according to claim 15, wherein a coating layer is provided on a surface of said base paper.
